(19) United States
(12) Patent Application Publication
(10) Pub. No.: US 2025/0373725 A1
(43) Pub. Date: Dec. 4, 2025

(54) COMMUNICATION METHOD, DEVICE, SYSTEM, AND SERVICE SERVER

(71) Applicant: Trung Nam Tran, Hanoi City (VN)

(72) Inventor: Trung Nam Tran, Hanoi City (VN)

(73) Assignee: ESIMPHONY MOBILE TELECOMMUNICATIONS TRADING COMPANY LIMITED, Hanoi City (VN)

(21) Appl. No.: 19/218,885

(22) Filed: May 27, 2025

(30) Foreign Application Priority Data
May 30, 2024 (VN) 1-2024-03933

(51) Int. Cl. H04M 3/42; H04W 8/18

(52) U.S. Cl. CPC H04M 3/42085; H04M 3/42059; H04W 8/18

(57) ABSTRACT

The present disclosure provides a communication method including: receiving, by a communication device of a caller, a communication request of the caller and a SIM (Subscriber Identification Module) number of a callee; sending the information to a service server; receiving, by the service server, the information from the communication device of the caller; based on the information, determining, by the service server, whether or not the SIM number of the callee is associated with a global user ID of the callee at the service server; wherein if yes, determining, by service server, statuses of the communication devices of the callee that having installed thereon the SIMs which are also associated with the global user ID of the callee, sending, by the service server to the communication device of the caller, an instruction to initialize a call to the communication device of the callee having the status meeting a pre-determined condition.

### TECHNICAL FIELD

The present disclosure relates to communication technologies, and more particularly, to a communication method, device, system, and a service server.

### BACKGROUND ART

With the development of the society, mobile phones and terminal devices having wireless communication functions are becoming more and more popular. The need for communication of people via those means is also increasing.

One of the current conventional manners for a user to communicate is to make a call or send a message via a subscriber number with a network operator, also known as the SIM (Subscriber Identification Module) number. Another conventional manner is to communicate via communication applications installed on a terminal device, such as Zalo, Facebook Messenger, WeChat, WhatsApp Messenger, Viber, etc., Another conventional manner is to communicate via the FaceTime and iMessage services integrated in device operating systems of Apple. And another conventional manner is to communicate via BBM (BlackBerry Messenger) service of BlackBerry.

However, if the communication is made via the SIM number only, the charges are usually high. When a callee has multiple SIMs, if a caller does not know which SIM the callee is currently using, the caller will have to manually select each SIM number of the callee until a connection is successful. When going abroad, it is necessary to register for an international roaming service, otherwise it is not feasible to contact. Communication charges in case of international roaming for both the caller and the callee are even higher. Even if a call forwarding service has been registered, the network operator just tries to, mechanically but not flexibly, forward a call to a registered SIM number.

With respect to communication via communication applications installed on a terminal device, a user has to register an account for a respective application. This approach is quite troublesome because if a user uses multiple applications, the user will need to register multiple accounts, making it difficult to manage accounts. A further problem is that, currently, those applications do not support cross-platform communication. That is, a user cannot use a Zalo account to call a Facebook Messenger account, and vice versa. Therefore, if a callee uses multiple types of communication applications and a caller does not know which communication application the callee is currently using, the caller still has to manually select a communication application which is in a same platform as the communication application that the callee is currently using (for example, both are Zalo or both are Facebook Messenger) until the connection is successful. In addition, this approach further has a drawback which is that a data connection or an IP (Internet Protocol) connection is always required. That is, those applications will not work if there is only a GSM (Global System for Mobile communication) connection.
With respect to communication via FaceTime and iMessage services of Apple, this approach has a drawback which is that it applies to Apple devices (i.e., iPhone, iPad, etc.) only. When a callee has multiple SIMs and if a caller does not know which SIM the callee is currently using, the caller will also have to manually select each SIM number of the callee until a connection is successful. In addition, this communication manner also requires an IP connection. That is, if there is just a GSM connection, FaceTime and iMessage will not work.
As for communication via BBM (BlackBerry Messenger) service of BlackBerry, this service can be used on both BlackBerry devices, in which BBM client is already integrated into the BBOS operating system, and devices from other manufacturers using other operating systems, such as Android, after installing BBM application. However, when the BBM service is used on BlackBerry devices, it has the drawbacks similar to those of the FaceTime and iMessage services of Apple. Whereas when the BBM service is used on devices from other manufacturers using other operating systems, it has the drawbacks similar to those of Zalo, Facebook Messenger services, etc., mentioned above.

### SUMMARY

In order to address the above problems of the prior art, by automatically selecting an IP connection or a GSM connection and automatically selecting a communication device of the callee to flexibly connect thereto so as to simplify the user communication, the present disclosure provides a communication method, device, system, and a service server.

Particularly, in a first aspect, the present disclosure provides a communication method. The method may include: receiving, by a communication device of a caller, a communication request of the caller and a SIM (Subscriber Identification Module) number of the callee input by the caller; sending, by the communication device of the caller, the communication request of the caller and the SIM number of the callee to a service server; receiving, by the service server, the communication request of the caller and the SIM number of the callee sent from the communication device of the caller; based on the communication request of the caller and the SIM number of the callee received from the communication device of the caller, determining, by the service server, whether or not the SIM number of the callee is associated with any global user ID of the callee at the service server, where the global user ID of the callee is an ID which is pre-registered at the service server by the callee and is associated with SIM numbers of the callee; wherein if the service server determines that the SIM number of the callee is associated with a global user ID of the callee at the service server, determining, by the service server, statuses of communication devices of the callee having installed thereon the SIMs which are also associated with the global user ID of the callee, sending, by the service server to the communication device of the caller, an instruction to initialize a call to the communication device of the callee that has the status meeting a pre-determined condition, via an IP (Internet Protocol) connection or a GSM (Global System for Mobile communication) connection; and initializing, by the communication device of the caller in accordance with the instruction of the service server, a call to the communication device of the callee that has the status meeting the pre-determined condition, via the IP connection or the GSM connection; or if the service server determines that the SIM number of the callee is not associated with any global user ID of the callee at the service server, sending, by the service server to the communication device of the caller, an instruction to initialize a call to the SIM number of the callee via a GSM connection; and initializing, by the communication device of the caller in accordance with the instruction of the service server, a call to the SIM number of the callee via the GSM connection.

In a second aspect, the present disclosure provides a communication device, the device may include a processor, a memory, an input/output and a transceiver, where the memory stores a computer program, and the processor is configured to execute the computer program stored in the memory to make the communication device: receive, by using the input/output, a communication request of the caller and a SIM (Subscriber Identification Module) number of the callee input by the caller; send, by using the transceiver, the communication request of the caller and the SIM number of the callee to a service server; read information about the SIM number installed on the device, an IMSI (International Mobile Subscriber Identity) number and a network code; receive, by using the transceiver, a status inquiry of the service server with respect to the SIM number installed on the device; send, by using the transceiver, the status and the SIM number, the IMSI number and the network code to the service server in response to the status inquiry; receive, by using the transceiver, an instruction to initialize a call from the service server; and initialize a call, by using the transceiver, in accordance with the instruction to initialize a call received from the service server.

In a third aspect, the present disclosure provides a service server, the service server may be applied to a communication system including a communication device of a caller, a communication device of a callee and the service server, where the service server may be a virtual machine using a cloud service of a third party including Microsoft Azure and Google Cloud, and the service server may include means configured to: receive a communication request of the caller and the SIM number of the callee sent from the communication device of the caller; based on the communication request of the caller and the SIM number of the callee received from the communication device of the caller, determine whether or not the SIM number of the callee is associated with any global user ID of the callee, where the global user ID of the callee is an ID which is pre-registered at the service server by the callee and is associated with SIM numbers of the callee; wherein if it is determined that the SIM number of the callee is associated with a global user ID of the callee, determine statuses of communication devices of the callee having installed thereon the SIMs which are also associated with the global user ID of the callee, send, to the communication device of the caller, an instruction to initialize a call to the communication device of the callee that has the status meeting a pre-determined condition, via an IP (Internet Protocol) connection or a GSM (Global System for Mobile communication) connection; and connect the communication device of the caller to the communication device of the callee if the call is initialized via an IP connection; or if it is determined that the SIM number of the callee is not associated with any global user ID, send, to the communication device of the caller, an instruction to initialize a call for the communication device of the caller to initialize a call to the SIM number of the callee via a GSM connection.

In a fourth aspect, the present disclosure provides a communication system, the system may include the communication device in the second aspect and the service server in the third aspect.

### BRIEF DESCRIPTION OF THE DRAWINGS

FIG. 1 illustrates a flow chart of the communication method in accordance with the present disclosure; and

FIG. 2 illustrates a schematic diagram of the communication system in accordance with the present disclosure to which the communication method in accordance with the present disclosure may be applied.

### DETAILED DESCRIPTION

Hereinafter, the communication method, device, system, and the service server in accordance with the present disclosure will be described in detail with reference to the accompanying drawings.

In a first embodiment, the present disclosure provides a communication method.

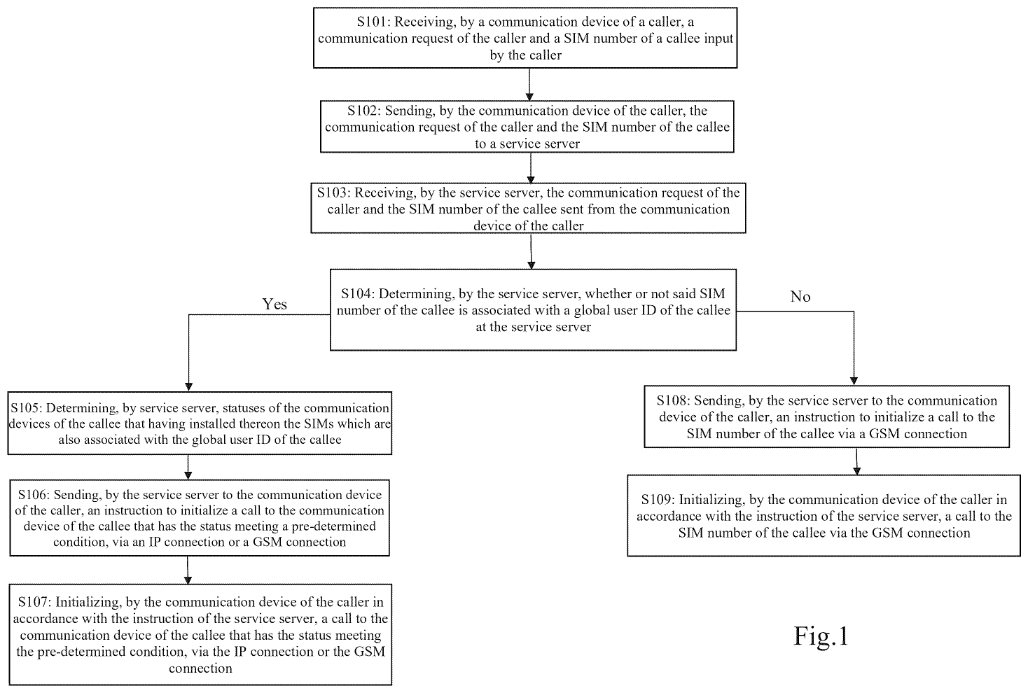

FIG. 1 illustrates a flow chart of the communication method in accordance with the present disclosure. As shown in FIG. 1, the communication method in accordance with the present disclosure may include, but is not limited to, the steps:

S101: Receiving, by a communication device of a caller, a communication request of the caller and a SIM (Subscriber Identification Module) number of the callee input by the caller. In this step, the communication device of the caller receives/obtains information about the callee, particularly the SIM number, such as by using a touch screen, a physical key or a voice recognition function of the communication device of the caller.

S102: Sending, by the communication device of the caller, the communication request of the caller and the SIM number of the callee to a service server. After having received the SIM number of the callee, the communication device of the caller sends the SIM number of the callee to the service server. The service server herein may be a virtual machine, may use a cloud service of a third party which may include Microsoft Azure and Google Cloud. It has functions of receiving the SIM number of the callee; determining whether or not the SIM number is associated with any global user ID of the callee, where the global user ID of the callee is an ID which is pre-registered at the service server by the callee and is associated with SIM numbers of the callee; if yes, determining statuses of communication devices of the callee that having installed thereon the SIMS which are also associated with the global user ID of the callee; sending the status meeting a pre-determined condition of the communication device of the callee and an instruction to the communication device of the caller for the communication device of the caller to initialize a call to that communication device of the callee; connecting the communication device of the caller to the communication device of the callee in case the call is initialized via an IP connection; otherwise, sending an instruction to the communication device of the caller for the communication device of the caller to initialize a call to the communication device of the callee via a GSM connection.

S103: Receiving, by the service server, the communication request of the caller and the SIM number of the callee sent from the communication device of the caller. After the communication device of the caller has sent the SIM number of the callee to the service server, correspondingly, the service server receives the SIM number.

S104: Determining, by the service server, whether or not the SIM number of the callee is associated with any global user ID of the callee at the service server, where the global user ID of the callee is an ID which is pre-registered at the service server by the callee and is associated with SIM numbers of the callee. After the service server has received the SIM number, first, it determines whether or not the SIM number is associated with a global user ID of the callee. There are two cases: The SIM number is associated with a global user ID together with other SIM numbers of the callee, or the SIM number is not associated with any global user ID of the callee.

If the service server determines that the SIM number of the callee is associated with a global user ID of the callee at the service server, the method further includes the steps:

S105: Determining, by service server, statuses of the communication devices of the callee that having installed thereon the SIMs which are also associated with the global user ID of the callee. If the SIM number is associated with a global user ID of the callee, the service server knows that the SIM number is related to other SIM numbers which are also associated with the global user ID, and it determines the statuses of all communication devices having installed thereon those SIMs. Then, the service server selects a device that has a status meeting a pre-determined condition and sends an instruction to the communication device of the caller for the communication device of the caller to initialize a call to the device having the status meeting the pre-determined condition. Here, the determining of statuses of the communication devices of the callee includes sub-operations/sub-steps of: reading, by the communication device of the callee, information about a SIM number being installed on the communication device of the callee, an IMSI (International Mobile Subscriber Identity) number and a network code; sending, by the service server, a status inquiry to the communication device of the callee for obtaining the above-mentioned information of the communication device of the callee; and sending, by the communication device of the callee, the above-mentioned information to the service server in response to the status inquiry.

S106: Sending, by the service server to the communication device of the caller, an instruction to initialize a call to the communication device of the callee that has the status meeting a pre-determined condition, via an IP (Internet Protocol) connection or a GSM (Global System for Mobile communication) connection. The pre-determined condition mentioned above includes, but is not limited to, at least one of: whether or not the IP connection quality between the communication device having installed thereon the called SIM of the callee and the communication device of the caller is greater than or equal to a pre-determined threshold; whether or not the IP connection quality between the communication devices having installed thereon other SIMs of the callee and the communication device of the caller is greater than or equal to a pre-determined threshold and what are the usage frequencies of those communication devices; whether or not the called SIM is in a same network as the calling SIM and whether or not the signal strength of the called SIM is greater than or equal to a pre-determined threshold; whether or not there is a SIM among the SIMs of the callee belonging to a same network as the calling SIM, and if yes, whether or not the signal strengths of those SIMs are greater than or equal to a pre-determined threshold and what are the usage frequencies of the communication devices having installed thereon those SIMs; whether or not the signal strengths of the SIMs of the callee are greater than or equal to a pre-determined threshold and what are the usage frequencies of the communication devices having installed thereon those SIMs; which SIM has the greatest signal strength among the SIMs of the callee; where if the IP connection quality between the communication device having installed thereon the called SIM of the callee and the communication device of the caller is greater than or equal to a pre-determined threshold, the service server selects that communication device of the callee and sends an instruction to the communication device of the caller to instruct the communication device of the caller to initialize a call to that communication device of the callee via the IP connection via the service server (that is, if the IP connection between the communication device of the caller and the device having installed thereon the called SIM is good enough, the service server selects that device and instructs the communication device of the caller to initialize a call to that device via the IP connection via the service server); or if the IP connection quality between the communication device having installed thereon the called SIM of the callee and the communication device of the caller is less than a pre-determined threshold, and the IP connection quality between the communication devices having installed thereon the other SIMs of the callee and the communication device of the caller is greater than or equal to a pre-determined threshold, the service server selects a communication device of the callee that has the greatest usage frequency among the communication devices having the IP connection quality greater than or equal to the pre-determined threshold, and sends an instruction to the communication device of the caller to instruct the communication device of the caller to initialize a call to that communication device of the callee via an IP connection via the service server, in case there are multiple communication devices of the callee simultaneously meeting the condition, the service server randomly selects one of those devices and sends an instruction to the communication device of the caller to instruct the communication device of the caller to initialize a call to that randomly selected communication device of the callee via an IP connection via the service server (that is, if the IP connection between the communication device of the caller and the device having installed thereon the called SIM is not good enough, and there are good enough IP connections to other devices of the callee, the service server selects the most frequently used device among the devices having the good enough IP connections and instructs the communication device of the caller to initialize a call to that device via an IP connection via the service server. In case there are multiple communication devices of the callee simultaneously meeting the condition, the service server randomly selects one of those devices); or if the IP connection quality between all communication devices of the callee and the communication device of the caller is less than a pre-determined threshold, and the called SIM belongs to a same network as the calling SIM and the signal strength of the called SIM is greater than or equal to a pre-determined threshold, the service server selects the communication device having installed thereon this SIM of the callee and sends an instruction to the communication device of the caller to instruct the communication device of the caller to initialize a call to the SIM number via a GSM connection (that is, if there is no IP connection which is good enough, and the called SIM is in a same network as the calling SIM and has a good enough signal, the service server selects the device having installed thereon the called SIM and instructs the communication device of the caller to initialize a call to that device via a GSM connection); or if the IP connection quality between all communication devices of the callee and the communication device of the caller is less than a pre-determined threshold, and the called SIM is not in a same network as the calling SIM or is in a same network as the calling SIM but the signal strength of the called SIM is less than a pre-determined threshold, and among the other SIMs of the callee there is one or more SIM in a same network as the calling SIM, and the signal strengths of the one or more SIM among the SIMs in a same network are greater than or equal to a pre-determined threshold, the service server selects the most frequently used communication device among the communication devices having installed thereon the SIMs in a same network as the calling SIM and having the signal strength being greater than or equal to the pre-determined threshold, and sends an instruction to the communication device of the caller to instruct the communication device of the caller to initialize a call to that SIM number via a GSM connection, in case there are multiple communication devices of the callee simultaneously meeting the condition, the service server randomly selects one of those devices and sends an instruction to the communication device of the caller to instruct the communication device of the caller to initialize a call to that SIM number being installed on the randomly selected device via a GSM connection (that is, if there is no IP connection which is good enough, and the called SIM is not in a same network as the calling SIM or is in a same network but the signal is not good enough, and there are other SIMs in a same network as the calling SIM and the signals are good enough, the service server selects the most frequently used device among those devices having installed thereon the SIMs in a same network and having the good enough signals, and instructs the communication device of the caller to initialize a call to that device via a GSM connection. In case there are multiple communication devices of the callee simultaneously meeting the condition, the service server randomly selects one of those devices); or if the IP connection quality between all communication devices of the callee and the communication device of the caller is less than a pre-determined threshold, and the called SIM is not in a same network as the calling SIM or is in a same network as the calling SIM but the signal strength of the called SIM is less than a pre-determined threshold, and among the other SIMs of the callee there is no SIM in a same network as the calling SIM or there are SIMs in a same network but the signal strengths thereof are all less than a pre-determined threshold, and among the other SIMs of the callee there is one or more SIM having a signal strength being greater than or equal to a pre-determined threshold, the service server selects the most frequently used communication device among the communication devices having installed thereon the SIMs having signal strengths greater than or equal to the pre-determined threshold, and sends an instruction to the communication device of the caller to instruct the communication device of the caller to initialize a call to that SIM number via a GSM connection, in case there are multiple communication devices of the callee simultaneously meeting the condition, the service server randomly selects one of those devices and sends an instruction to the communication device of the caller to instruct the communication device of the caller to initialize a call to the SIM number being installed on that randomly selected device via a GSM connection (that is, if there is no IP connection which is good enough, and the called SIM is not in a same network as the calling SIM or is in a same network but the signal is not good enough, and among the other SIMs of the callee there is no SIM in a same network as the calling SIM or there are SIMs in a same network but the signals thereof are all not good enough, and there is one or more remaining SIM having a good enough signal, the service server selects the most frequently used device among the devices having installed thereon the SIMs having the good enough signals, and instructs the communication device of the caller to initialize a call to that device via a GSM connection. In case there are multiple communication devices of the callee simultaneously meeting the condition, the service server randomly selects one of those devices); or if the IP connection quality between all communication devices of the callee and the communication device of the caller is less than a pre-determined threshold, and the signal strengths of all the SIMs of the callee are all less than a pre-determined threshold, the service server selects a communication device having installed thereon the SIM having the greatest signal strength among them, and sends an instruction to the communication device of the caller to instruct the communication device of the caller to initialize a call to that SIM number via a GSM connection, in case there are multiple communication devices of the callee simultaneously meeting the condition, the service server randomly selects one of those devices and sends an instruction to the communication device of the caller to instruct the communication device of the caller to initialize a call to the SIM number being installed on that randomly selected device via a GSM connection (that is, if there is no IP connection which is good enough, and all the SIMs of the callee do not have a good enough signal, the service server selects a device having installed thereon a SIM having the greatest signal among them, and instructs the communication device of the caller to initialize a call to that device via a GSM connection. In case there are multiple communication devices of the callee simultaneously meeting the condition, the service server randomly selects one of those devices).

S107: Initializing, by the communication device of the caller in accordance with the instruction of the service server, a call to the communication device of the callee that has the status meeting the pre-determined condition, via the IP connection or the GSM connection.

If the service server determines that the SIM number of the callee is not associated with any global user ID of the callee at the service server, the method further includes the steps:

S108: Sending, by the service server to the communication device of the caller, an instruction to initialize a call to the SIM number of the callee via a GSM connection.

S109: Initializing, by the communication device of the caller in accordance with the instruction of the service server, a call to the SIM number of the callee via the GSM connection.

Practically, the callee may have just bought one more new SIM and has not yet associated or does not want to associate the newly bought SIM number with his/her global user ID at the service server, and the caller may be calling to that newly bought SIM number. So, the service server does not know whether or not the SIM number is related to other SIM numbers of the callee, and it just sends an instruction to the calling device for the calling device to initialize a call to the SIM number via a GSM connection.

In this embodiment, when a call is initialized via an IP connection between the communication device of the caller and the communication device of the callee, the call may be implemented by a client that is integrated into the operating system of the communication device or installed as a dedicated tool on the communication device; or when a call is initialized via a GSM connection between the communication device of the caller and the communication device of the callee, the call may be implemented by a call tool of the operating system of the communication device.

The communication device of the caller and the communication device of the callee may be a mobile phone, a tablet, a personal computer or any other device that has a wireless communication capability via a GSM connection and/or an IP connection. The communication request herein is at least one of, but is not limited to, a calling operation, including a voice call and a video call, a messaging operation, including an SMS (Short Message Service) message and an MMS (Multimedia Message Service) message. The SIM number is the mobile subscription number in domestic or international networks, such as Viettel, Vina Phone, Mobile Phone, AT&T, Verizon networks, etc.

The registration for a global user ID at the service server, the association of SIM numbers with a global user ID, the determination of statuses of communication devices (for example, determination of signal strength, usage frequency of a device, etc.), may be implemented by prior arts and are not described in detail herein for the sake of brevity.

In a second embodiment, the present disclosure provides a communication device, the device may include, but is not limited to, a processor, a memory, an input/output and a transceiver, where the memory stores a computer program, and the processor is configured to execute the computer program stored in the memory to make the communication device receive, by using the input/output, a communication request of the caller and a SIM (Subscriber Identification Module) number of the callee input by the caller; send, by using the transceiver, the communication request of the caller and the SIM number of the callee to a service server; read information about the SIM number installed on the device, an IMSI (International Mobile Subscriber Identity) number and a network code; receive, by using the transceiver, a status inquiry of the service server with respect to the SIM number installed on the device; send, by using the transceiver, the status and the SIM number, the IMSI number and the network code to the service server in response to the status inquiry; receive, by using the transceiver, an instruction to initialize a call from the service server; and initialize a call, by using the transceiver, in accordance with the instruction to initialize a call received from the service server. Details of the operations of the device may be found in the description about the corresponding steps/operations of the method in the first embodiment and are not repeated here for the sake of brevity.

The device may be a communication device of a caller or a communication device of a callee, depending on the context. For example, when the device is the device that initializes a call, it is the communication device of a caller. Whereas, when the device is the device that receives a call, it is the communication device of a callee.

In a third embodiment, the present disclosure provides a service server, the server may be applied to a communication system including a communication device of a caller, a communication device of a callee and the service server, where the service server may be a virtual machine using a cloud service of a third party which may include Microsoft Azure and Google Cloud, and the service server may include means configured to: receive a communication request of the caller and the SIM (Subscriber Identification Module) number of the callee sent from the communication device of the caller; based on the communication request of the caller and the SIM number of the callee received from the communication device of the caller, determine whether or not the SIM number of the callee is associated with any global user ID of the callee, where the global user ID of the callee is an ID which is pre-registered at the service server by the callee and is associated with SIM numbers of the callee; wherein if it is determined that the SIM number of the callee is associated with a global user ID of the callee, determine statuses of communication devices of the callee having installed thereon the SIMs which are also associated with the global user ID of the callee, send, to the communication device of the caller, an instruction to initialize a call to the communication device of the callee that has the status meeting a pre-determined condition, via an IP (Internet Protocol) connection or a GSM (Global System for Mobile communication) connection; and connect the communication device of the caller to the communication device of the callee if the call is initialized via an IP connection; or if it is determined that the SIM number of the callee is not associated with any global user ID, send, to the communication device of the caller, an instruction to initialize a call for the communication device of the caller to initialize a call to the SIM number of the callee via a GSM connection. Details of the operations of the service server may be found in the description about the corresponding steps/operations of the method in the first embodiment and are not repeated here for the sake of brevity.

In a fourth embodiment, the present disclosure provides a communication system, the system may include, but is not limited to, the communication device of a caller and the communication device of a callee in the second embodiment and the service server in the third embodiment.

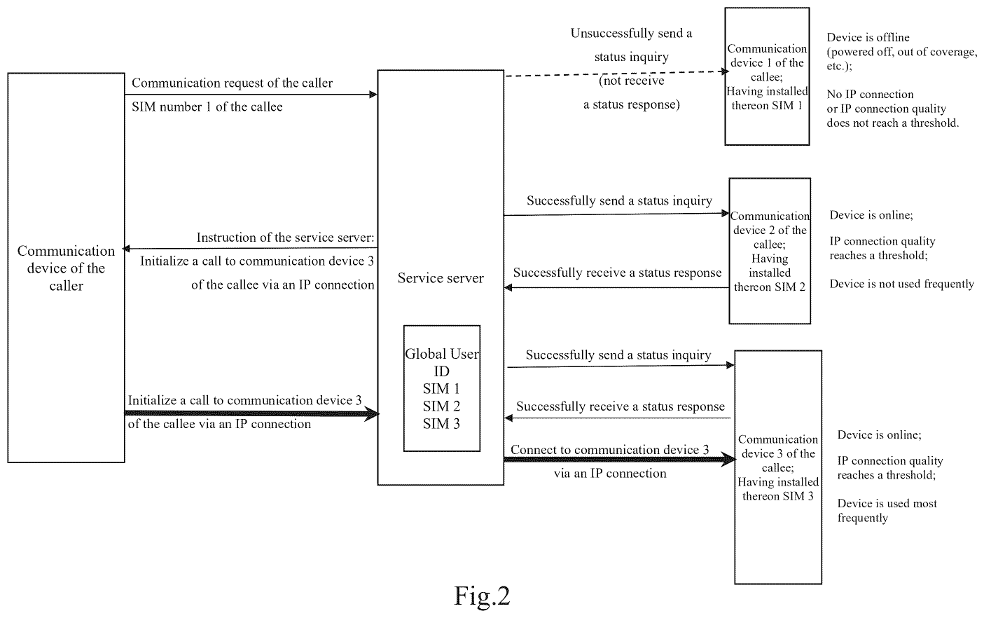

FIG. 2 illustrates a schematic diagram of the communication system in this embodiment of the present disclosure to which the communication method in the first embodiment of the present disclosure may be applied. For the sake of simplicity, this drawing illustrates that the system just includes one communication device of a caller, one service server, three communication devices of a callee which are the communication device 1 of the callee, the communication device 2 of the callee, and the communication device 3 of the callee, where there is just one global user ID of the callee being registered at the service server and associated with three SIM numbers of SIM 1, SIM 2 and SIM 3 that are respectively installed on the three communication devices of the callee. However, practically, the number of communication devices may be greater, and the number of SIMs may also be greater.

One example of the operation of this system is as follows. Assuming that the communication device of the caller has a good signal (the IP connection of this device has the quality reaching a threshold). When the caller makes a call to the SIM number 1 of the callee, the communication device of the caller sends a communication request of the caller and the SIM number 1 of the callee to the service server. Previously, the callee has registered for a global user ID at the service server and associated the SIM number 1, the SIM number 2 and the SIM number 3 with the global user ID. The service server receives the communication request and the SIM number 1 from the communication device of the caller, determines that the SIM number 1 is associated with the global user ID together with the SIM number 2 and the SIM number 3 of the callee. Therefore, the service server determines the statuses of all the three devices having installed thereon the three SIMs by sending status inquiries to those three devices. As shown in the drawing, among the three communication devices, the communication device 1 having installed thereon SIM 1 is in an offline status (for example, due to being powered off or out of coverage) and the service server cannot send a status inquiry to this device, and therefore, does not receive a status response from this device. This means that the status of the communication device 1 of the callee is un-connectable or unreachable (represented by a dashed arrow). Therefore, the service server does not select this device. The communication device 2 having installed thereon SIM 2 is in an online status and the service server successfully sends a status inquiry to and successfully receives a status response from the communication device 2 of the callee. As such, the status of the communication device 2 of the callee is connectable or reachable. In addition, this device further has an IP connection whose quality reaches a threshold. However, the service server does not select this device as well because this device is not used frequently. The communication device 3 having installed thereon SIM 3 is also in an online status as it has good signal quality, so the service server successfully sends a status inquiry to and successfully receives a status response from the communication device 3 of the callee. As such, the status of the communication device 3 of the callee is connectable or reachable. In addition, the IP connection quality of this device reaches a threshold and this device is used the most frequently. Therefore, the service server selects the communication device 3 of the callee and sends an instruction to the communication device of the caller, where the instruction is to initialize a call to the communication device 3 of the callee via an IP connection via the service server. Accordingly, the communication device of the caller initializes a call to the communication device 3 of the callee via an IP connection via the service server, and the service server connects the communication device of the caller to the communication device of the callee via the IP connection (represented by a bold solid arrow).

The above is merely an example of possible cases in this communication system. For other cases, such as a case in which the communication device of the caller does not have an IP connection or does have one but the quality thereof does not reach a threshold, or a case in which the communication device 1 of the callee having installed thereon SIM 1 and has an IP connection with quality reaching a threshold and this device is used the most frequently, or a case in which there is no IP connection between the communication device of the caller and the communication device of the callee, or a case in which the called SIM is in a same network or is not in a same network as the calling SIM, or a case in which there is no SIM among the SIMs of the callee belonging to a same network as the calling SIM, etc., the principle is similar to that described above and is not described here for the sake of brevity.

By the solution of the present disclosure, the user communication may be simplified. In case a callee has multiple SIM numbers and a caller just knows one of those SIM numbers, and even if that known SIM number is in an unreachable status, thanks to the service server the communication device of the caller may still be connected to a communication device having installed thereon another SIM of the callee. The connection between the communication device of the caller and the communication device of the callee is not limited to a GSM connection, but may automatically be selected flexibly between a GSM connection and an IP connection to ensure the availability of connection and the cost-saving. When going abroad, a user does not necessarily have to register for an international roaming service while his/her device may still be connected to the device of a caller. Further, the solution of the present disclosure may be applied to devices of various manufacturers using various operating systems.

The above description is provided by using the making of a call as an example. With respect to messaging, the principle is similar to that when making a call and is not described here for the sake of brevity.

In summary, the present disclosure provides a communication method including: receiving, by a communication device of a caller, a communication request of the caller and a SIM (Subscriber Identification Module) number of a callee; sending said information to a service server; receiving, by the service server, said information from the communication device of the caller; based on said information, determining, by the service server, whether or not said SIM number of the callee is associated with a global user ID of the callee at the service server; wherein if yes, determining, by service server, statuses of the communication devices of the callee that having installed thereon the SIMS which are also associated with the global user ID of the callee, sending, by the service server to the communication device of the caller, an instruction to initialize a call to the communication device of the callee that has the status meeting a pre-determined condition, via an IP (Internet Protocol) connection or a GSM (Global System for Mobile communication) connection; and initializing, by the communication device of the caller in accordance with the instruction of the service server, a call to the communication device of the callee that has the status meeting the pre-determined condition, via the IP connection or the GSM connection; otherwise, sending, by the service server to the communication device of the caller, an instruction to initialize a call to the SIM number of the callee via a GSM connection; and initializing, by the communication device of the caller in accordance with the instruction of the service server, a call to the SIM number of the callee via the GSM connection. The present disclosure further provides a communication device and system and a service server.

The order of the operations/steps mentioned above is merely provided as an example but is not intended to limiting the present disclosure. That is, those operations/steps may be performed in other orders, as long as they are logically appropriate and do not conflict one another.

The terms used herein have common meanings as usually understood by an ordinary skilled in the art, unless otherwise stated.

An ordinary skilled in the art would see that modifications, variations and substitutions may be made to the communication method, device and system and the service server of the present disclosure without departing from the scope of the present disclosure. Therefore, the scope of the present disclosure is defined by the scope of the accompanying claims.

1. A communication method, wherein the method including:
receiving, by a communication device of a caller, a communication request of the caller and a SIM (Subscriber Identification Module) number of the callee input by the caller;
sending, by the communication device of the caller, the communication request of the caller and the SIM number of the callee to a service server;
receiving, by the service server, the communication request of the caller and the SIM number of the callee sent from the communication device of the caller;
based on the communication request of the caller and the SIM number of the callee received from the communication device of the caller,
determining, by the service server, whether or not the SIM number of the callee is associated with any global user ID of the callee at the service server, where the global user ID of the callee is an ID which is pre-registered at the service server by the callee and is associated with SIM numbers of the callee;
wherein
if the service server determines that the SIM number of the callee is associated with a global user ID of the callee at the service server,
determining, by service server, statuses of the communication devices of the callee that having installed thereon the SIMs which are also associated with the global user ID of the callee,
sending, by the service server to the communication device of the caller, an instruction to initialize a call to the communication device of the callee that has the status meeting a pre-determined condition, via an IP (Internet Protocol) connection or a GSM (Global System for Mobile communication) connection; and
initializing, by the communication device of the caller in accordance with the instruction of the service server, a call to the communication device of the callee that has the status meeting the pre-determined condition, via the IP connection or the GSM connection;
or
if the service server determines that the SIM number of the callee is not associated with any global user ID of the callee at the service server,
sending, by the service server to the communication device of the caller, an instruction to initialize a call to the SIM number of the callee via a GSM connection; and
initializing, by the communication device of the caller in accordance with the instruction of the service server, a call to the SIM number of the callee via the GSM connection.

2. The communication method according to claim 1, wherein the service server including means configured to:
receive a communication request of the caller and the SIM number of the callee sent from the communication device of the caller;
based on the communication request of the caller and the SIM number of the callee received from the communication device of the caller,
determine whether or not the SIM number of the callee is associated with any global user ID of the callee, where the global user ID of the callee is an ID which is pre-registered at the service server by the callee and is associated with SIM numbers of the callee;
wherein
if it is determined that the SIM number of the callee is associated with a global user ID of the callee,
determine statuses of the communication devices of the callee that having installed thereon the SIMs which are also associated with the global user ID of the callee,
send, to the communication device of the caller, an instruction to initialize a call to the communication device of the callee that has the status meeting a pre-determined condition, via an IP connection or a GSM connection; and
connect the communication device of the caller to the communication device of the callee if the call is initialized via an IP connection;
or
if it is determined that the SIM number of the callee is not associated with any global user ID of the callee,
send, to the communication device of the caller, an instruction to initialize a call for the communication device of the caller to initialize a call to the SIM number of the callee via a GSM connection.

3. The communication method according to claim 1, wherein the service server is a virtual machine, using a cloud service of a third party including Microsoft Azure and Google Cloud.

4. The communication method according to claim 1, wherein the determining of the status of the communication devices of the callee includes:
reading, by the communication device of the callee, information about a SIM number being installed on the communication device of the callee, an IMSI (International Mobile Subscriber Identity) number and a network code;
sending, by the service server, a status inquiry to the communication device of the callee for obtaining the above-mentioned information of the communication device of the callee; and
sending, by the communication device of the callee, the above-mentioned information to the service server in response to the status inquiry.

5. The communication method according to claim 1, wherein the pre-determined condition includes at least one of:
whether or not the IP connection quality between the communication device having installed thereon the called SIM of the callee and the communication device of the caller is greater than or equal to a pre-determined threshold;
whether or not the IP connection quality between the communication devices having installed thereon other SIMs of the callee and the communication device of the caller is greater than or equal to a pre-determined threshold and what are the usage frequencies of those communication devices;
whether or not the called SIM is in a same network as the calling SIM and whether or not the signal strength of the called SIM is greater than or equal to a pre-determined threshold;
whether or not there is a SIM among the SIMs of the callee belonging to a same network as the calling SIM, and if yes, whether or not the signal strengths of those SIMs are greater than or equal to a pre-determined threshold and what are the usage frequencies of the communication devices having installed thereon those SIMs;
whether or not the signal strengths of the SIMs of the callee are greater than or equal to a pre-determined threshold and what are the usage frequencies of the communication devices having installed thereon those SIMs;
which SIM has the greatest signal strength among the SIMs of the callee.

6. The communication method according to claim 5, wherein:
if the IP connection quality between the communication device having installed thereon the called SIM of the callee and the communication device of the caller is greater than or equal to a pre-determined threshold, the service server selects that communication device of the callee and sends an instruction to the communication device of the caller to instruct the communication device of the caller to initialize a call to that communication device of the callee via the IP connection via the service server.

7. The communication method according to claim 5, wherein:
if the IP connection quality between the communication device having installed thereon the called SIM of the callee and the communication device of the caller is less than a pre-determined threshold, and the IP connection quality between the communication devices having installed thereon the other SIMs of the callee and the communication device of the caller is greater than or equal to a pre-determined threshold, the service server selects the communication device of the callee that has the greatest usage frequency among the communication devices having IP connection quality being greater than or equal to the pre-determined threshold, and sends an instruction to the communication device of the caller to instruct the communication device of the caller to initialize a call to the communication device of the callee via an IP connection via the service server, in case there are multiple communication devices of the callee simultaneously meeting the condition, the service server randomly selects one of those devices and sends an instruction to the communication device of the caller to instruct the communication device of the caller to initialize a call to that randomly selected communication device of the callee via an IP connection via the service server.

8. The communication method according to claim 5, wherein:
if the IP connection quality between all communication devices of the callee and the communication device of the caller is less than a pre-determined threshold, and the called SIM belongs to a same network as the calling SIM and the signal strength of the called SIM is greater than or equal to a pre-determined threshold, the service server selects the communication device having installed thereon this SIM of the callee and sends an instruction to the communication device of the caller to instruct the communication device of the caller to initialize a call to the SIM number via a GSM connection.

9. The communication method according to claim 5, wherein:
if the IP connection quality between all communication devices of the callee and the communication device of the caller is less than a pre-determined threshold, and the called SIM is not in a same network as the calling SIM or is in a same network as the calling SIM but the signal strength of the called SIM is less than a pre-determined threshold, and among the other SIMs of the callee there is one or more SIM in a same network as the calling SIM, and the signal strengths of the one or more SIM among the SIMs in a same network are greater than or equal to a pre-determined threshold, the service server selects the most frequently used communication device among the communication devices having installed thereon the SIMs in a same network as the calling SIM and having the signal strength being greater than or equal to the pre-determined threshold, and sends an instruction to the communication device of the caller to instruct the communication device of the caller to initialize a call to that SIM number via a GSM connection, in case there are multiple communication devices of the callee simultaneously meeting the condition, the service server randomly selects one of those devices and sends an instruction to the communication device of the caller to instruct the communication device of the caller to initialize a call to that SIM number being installed on the randomly selected device via a GSM connection.

10. The communication method according to claim 5, wherein:
if the IP connection quality between all communication devices of the callee and the communication device of the caller is less than a pre-determined threshold, and the called SIM is not in a same network as the calling SIM or is in a same network as the calling SIM but the signal strength of the called SIM is less than a pre-determined threshold, and among the other SIMs of the callee there is no SIM in a same network as the calling SIM or there are SIMs in a same network but the signal strengths thereof are all less than a pre-determined threshold, and among the other SIMs of the callee there is one or more SIM having a signal strength being greater than or equal to a pre-determined threshold, the service server selects the most frequently used communication device among the communication devices having installed thereon the SIMS having signal strengths greater than or equal to the pre-determined threshold, and sends an instruction to the communication device of the caller to instruct the communication device of the caller to initialize a call to that SIM number via a GSM connection, in case there are multiple communication devices of the callee simultaneously meeting the condition, the service server randomly selects one of those devices and sends an instruction to the communication device of the caller to instruct the communication device of the caller to initialize a call to the SIM number being installed on that randomly selected device via a GSM connection.

11. The communication method according to claim 5, wherein:
if the IP connection quality between all communication devices of the callee and the communication device of the caller is less than a pre-determined threshold, and the signal strengths of all the SIMs of the callee are all less than a pre-determined threshold, the service server selects a communication device having installed thereon the SIM having the greatest signal strength among them, and sends an instruction to the communication device of the caller to instruct the communication device of the caller to initialize a call to that SIM number via a GSM connection, in case there are multiple communication devices of the callee simultaneously meeting the condition, the service server randomly selects one of those devices and sends an instruction to the communication device of the caller to instruct the communication device of the caller to initialize a call to the SIM number being installed on that randomly selected device via a GSM connection.

12. The communication method according to claim 1, wherein:
when a call is initialized via an IP connection between the communication device of the caller and the communication device of the callee, the call is implemented by a client that is integrated into the operating system of the communication device or installed as a dedicated tool on the communication device; or
when a call is initialized via a GSM connection between the communication device of the caller and the communication device of the callee, the call is implemented by a call tool of the operating system of the communication device.

13. A communication device, including a processor, a memory, an input/output and a transceiver, where the memory stores a computer program, and the processor is configured to execute the computer program stored in the memory to make the communication device:
receive, by using the input/output, a communication request of the caller and a SIM (Subscriber Identification Module) number of the callee input by the caller;
send, by using the transceiver, the communication request of the caller and the SIM number of the callee to a service server;
read information about the SIM number installed on the device, an IMSI (International Mobile Subscriber Identity) number and a network code;
receive, by using the transceiver, a status inquiry of the service server with respect to the SIM number installed on the device;
send, by using the transceiver, the status and the SIM number, the IMSI number and the network code to the service server in response to the status inquiry;
receive, by using the transceiver, an instruction to initialize a call from the service server; and
initialize a call, by using the transceiver, in accordance with the instruction to initialize a call received from the service server.

14. The communication device according to claim 13, wherein the service server including means configured to:
receive a communication request of the caller and the SIM number of the callee sent from the communication device of the caller;
based on the communication request of the caller and the SIM number of the callee received from the communication device of the caller,
determine whether or not the SIM number of the callee is associated with any global user ID of the callee, where the global user ID of the callee is an ID which is pre-registered at the service server by the callee and is associated with SIM numbers of the callee;
wherein
if it is determined that the SIM number of the callee is associated with a global user ID of the callee,
determine statuses of the communication devices of the callee that having installed thereon the SIMs which are also associated with the global user ID of the callee,
send, to the communication device of the caller, an instruction to initialize a call to the communication device of the callee that has the status meeting a pre-determined condition, via an IP (Internet Protocol) connection or a GSM (Global System for Mobile communication) connection; and
connect the communication device of the caller to the communication device of the callee if the call is initialized via an IP connection;
or
if it is determined that the SIM number of the callee is not associated with any global user ID of the callee,
send, to the communication device of the caller, an instruction to initialize a call for the communication device of the caller to initialize a call to the SIM number of the callee via a GSM connection.

15. The communication device according to claim 13, wherein the service server is a virtual machine, using a cloud service of a third party including Microsoft Azure and Google Cloud.

16. The communication device according to claim 14, wherein that the service server determines statuses of the communication devices of the callee includes:
reading, by the communication device of the callee, information about a SIM number being installed on the communication device of the callee, an IMSI (International Mobile Subscriber Identity) number and a network code;
sending, by the service server, a status inquiry to the communication device of the callee for obtaining the above-mentioned information of the communication device of the callee; and
sending, by the communication device of the callee, the above-mentioned information to the service server in response to the status inquiry.

17. The communication device according to claim 14, wherein the pre-determined condition includes at least one of:
whether or not the IP connection quality between the communication device having installed thereon the called SIM of the callee and the communication device of the caller is greater than or equal to a pre-determined threshold;
whether or not the IP connection quality between the communication devices having installed thereon other SIMs of the callee and the communication device of the caller is greater than or equal to a pre-determined threshold and what are the usage frequencies of those communication devices;
whether or not the called SIM is in a same network as the calling SIM and whether or not the signal strength of the called SIM is greater than or equal to a pre-determined threshold;
whether or not there is a SIM among the SIMS of the callee belonging to a same network as the calling SIM, and if yes, whether or not the signal strengths of those SIMs are greater than or equal to a pre-determined threshold and what are the usage frequencies of the communication devices having installed thereon those SIMs;
whether or not the signal strengths of the SIMs of the callee are greater than or equal to a pre-determined threshold and what are the usage frequencies of the communication devices having installed thereon those SIMs;
which SIM has the greatest signal strength among the SIMs of the callee.

18. The communication device according to claim 17, wherein:
if the IP connection quality between the communication device having installed thereon the called SIM of the callee and the communication device of the caller is greater than or equal to a pre-determined threshold, the service server selects that communication device of the callee and sends an instruction to the communication device of the caller to instruct the communication device of the caller to initialize a call to that communication device of the callee via the IP connection via the service server.

19. The communication device according to claim 17, wherein:
if the IP connection quality between the communication device having installed thereon the called SIM of the callee and the communication device of the caller is less than a pre-determined threshold, and the IP connection quality between the communication devices having installed thereon the other SIMs of the callee and the communication device of the caller is greater than or equal to a pre-determined threshold, the service server selects the communication device of the callee that has the greatest usage frequency among the communication devices having IP connection quality being greater than or equal to the pre-determined threshold, and sends an instruction to the communication device of the caller to instruct the communication device of the caller to initialize a call to the communication device of the callee via an IP connection via the service server, in case there are multiple communication devices of the callee simultaneously meeting the condition, the service server randomly selects one of those devices and sends an instruction to the communication device of the caller to instruct the communication device of the caller to initialize a call to that randomly selected communication device of the callee via an IP connection via the service server.

20. The communication device according to claim 17, wherein:
if the IP connection quality between all communication devices of the callee and the communication device of the caller is less than a pre-determined threshold, and the called SIM belongs to a same network as the calling SIM and the signal strength of the called SIM is greater than or equal to a pre-determined threshold, the service server selects the communication device having installed thereon this SIM of the callee and sends an instruction to the communication device of the caller to instruct the communication device of the caller to initialize a call to the SIM number via a GSM connection.

21. The communication device according to claim 17, wherein:
if the IP connection quality between all communication devices of the callee and the communication device of the caller is less than a pre-determined threshold, and the called SIM is not in a same network as the calling SIM or is in a same network as the calling SIM but the signal strength of the called SIM is less than a pre-determined threshold, and among the other SIMs of the callee there is one or more SIM in a same network as the calling SIM, and the signal strengths of the one or more SIM among the SIMs in a same network are greater than or equal to a pre-determined threshold, the service server selects the most frequently used communication device among the communication devices having installed thereon the SIMs in a same network as the calling SIM and having the signal strength being greater than or equal to the pre-determined threshold, and sends an instruction to the communication device of the caller to instruct the communication device of the caller to initialize a call to that SIM number via a GSM connection, in case there are multiple communication devices of the callee simultaneously meeting the condition, the service server randomly selects one of those devices and sends an instruction to the communication device of the caller to instruct the communication device of the caller to initialize a call to that SIM number being installed on the randomly selected device via a GSM connection.

22. The communication device according to claim 17, wherein:
if the IP connection quality between all communication devices of the callee and the communication device of the caller is less than a pre-determined threshold, and the called SIM is not in a same network as the calling SIM or is in a same network as the calling SIM but the signal strength of the called SIM is less than a pre-determined threshold, and among the other SIMs of the callee there is no SIM in a same network as the calling SIM or there are SIMs in a same network but the signal strengths thereof are all less than a pre-determined threshold, and among the other SIMs of the callee there is one or more SIM having a signal strength being greater than or equal to a pre-determined threshold, the service server selects the most frequently used communication device among the communication devices having installed thereon the SIMs having signal strengths greater than or equal to the pre-determined threshold, and sends an instruction to the communication device of the caller to instruct the communication device of the caller to initialize a call to that SIM number via a GSM connection, in case there are multiple communication devices of the callee simultaneously meeting the condition, the service server randomly selects one of those devices and sends an instruction to the communication device of the caller to instruct the communication device of the caller to initialize a call to the SIM number being installed on that randomly selected device via a GSM connection.

23. The communication device according to claim 17, wherein:
if the IP connection quality between all communication devices of the callee and the communication device of the caller is less than a pre-determined threshold, and the signal strengths of all the SIMs of the callee are all less than a pre-determined threshold, the service server selects a communication device having installed thereon the SIM having the greatest signal strength among them, and sends an instruction to the communication device of the caller to instruct the communication device of the caller to initialize a call to that SIM number via a GSM connection, in case there are multiple communication devices of the callee simultaneously meeting the condition, the service server randomly selects one of those devices and sends an instruction to the communication device of the caller to instruct the communication device of the caller to initialize a call to the SIM number being installed on that randomly selected device via a GSM connection.

24. The communication device according to claim 14, wherein
when a call is initialized via an IP connection between the communication device of the caller and the communication device of the callee, the call is implemented by a client that is integrated into the operating system of the communication device or installed as a dedicated tool on the communication device; or
when a call is initialized via a GSM connection between the communication device of the caller and the communication device of the callee, the call is implemented by a call tool of the operating system of the communication device.

25. A service server, applied to a communication system including a communication device of a caller, a communication device of a callee and the service server, wherein the service server including means configured to:
receive a communication request of the caller and the SIM (Subscriber Identification Module) number of the callee sent from the communication device of the caller;
based on the communication request of the caller and the SIM number of the callee received from the communication device of the caller,
determine whether or not the SIM number of the callee is associated with any global user ID of the callee, where the global user ID of the callee is an ID which is pre-registered at the service server by the callee and is associated with SIM numbers of the callee;
wherein
if it is determined that the SIM number of the callee is associated with a global user ID of the callee,
determine statuses of the communication devices of the callee that having installed thereon the SIMs which are also associated with the global user ID of the callee,
send, to the communication device of the caller, an instruction to initialize a call to the communication device of the callee that has the status meeting a pre-determined condition, via an IP (Internet Protocol) connection or a GSM (Global System for Mobile communication) connection; and
connect the communication device of the caller to the communication device of the callee if the call is initialized via an IP connection;
or
if it is determined that the SIM number of the callee is not associated with any global user ID of the callee,
send, to the communication device of the caller, an instruction to initialize a call for the communication device of the caller to initialize a call to the SIM number of the callee via a GSM connection.

26. The service server according to claim 25, wherein the service server is a virtual machine, using a cloud service of a third party including Microsoft Azure and Google Cloud.

27. The service server according to claim 25, wherein that the service server determines statuses of the communication devices of the callee includes:
reading, by the communication device of the callee, information about a SIM number being installed on the communication device of the callee, an IMSI (International Mobile Subscriber Identity) number and a network code;
sending, by the service server, a status inquiry to the communication device of the callee for obtaining the above-mentioned information of the communication device of the callee; and
sending, by the communication device of the callee, the above-mentioned information to the service server in response to the status inquiry.

28. The service server according to claim 25, wherein the pre-determined condition includes at least one of:
whether or not the IP connection quality between the communication device having installed thereon the called SIM of the callee and the communication device of the caller is greater than or equal to a pre-determined threshold;
whether or not the IP connection quality between the communication devices having installed thereon other SIMs of the callee and the communication device of the caller is greater than or equal to a pre-determined threshold and what are the usage frequencies of those communication devices;
whether or not the called SIM is in a same network as the calling SIM and whether or not the signal strength of the called SIM is greater than or equal to a pre-determined threshold;
whether or not there is a SIM among the SIMs of the callee belonging to a same network as the calling SIM, and if yes, whether or not the signal strengths of those SIMs are greater than or equal to a pre-determined threshold and what are the usage frequencies of the communication devices having installed thereon those SIMs;
whether or not the signal strengths of the SIMs of the callee are greater than or equal to a pre-determined threshold and what are the usage frequencies of the communication devices having installed thereon those SIMs;
which SIM has the greatest signal strength among the SIMs of the callee.

29. The service server according to claim 28, wherein:
if the IP connection quality between the communication device having installed thereon the called SIM of the callee and the communication device of the caller is greater than or equal to a pre-determined threshold, the service server selects that communication device of the callee and sends an instruction to the communication device of the caller to instruct the communication device of the caller to initialize a call to that communication device of the callee via the IP connection via the service server.

30. The service server according to claim 28, wherein:
if the IP connection quality between the communication device having installed thereon the called SIM of the callee and the communication device of the caller is less than a pre-determined threshold, and the IP connection quality between the communication devices having installed thereon the other SIMs of the callee and the communication device of the caller is greater than or equal to a pre-determined threshold, the service server selects the communication device of the callee that has the greatest usage frequency among the communication devices having IP connection quality being greater than or equal to the pre-determined threshold, and sends an instruction to the communication device of the caller to instruct the communication device of the caller to initialize a call to the communication device of the callee via an IP connection via the service server, in case there are multiple communication devices of the callee simultaneously meeting the condition, the service server randomly selects one of those devices and sends an instruction to the communication device of the caller to instruct the communication device of the caller to initialize a call to that randomly selected communication device of the callee via an IP connection via the service server.

31. The service server according to claim 28, wherein:
if the IP connection quality between all communication devices of the callee and the communication device of the caller is less than a pre-determined threshold, and the called SIM belongs to a same network as the calling SIM and the signal strength of the called SIM is greater than or equal to a pre-determined threshold, the service server selects the communication device having installed thereon this SIM of the callee and sends an instruction to the communication device of the caller to instruct the communication device of the caller to initialize a call to the SIM number via a GSM connection.

32. The service server according to claim 28, wherein:
if the IP connection quality between all communication devices of the callee and the communication device of the caller is less than a pre-determined threshold, and the called SIM is not in a same network as the calling SIM or is in a same network as the calling SIM but the signal strength of the called SIM is less than a pre-determined threshold, and among the other SIMs of the callee there is one or more SIM in a same network as the calling SIM, and the signal strengths of the one or more SIM among the SIMs in a same network are greater than or equal to a pre-determined threshold, the service server selects the most frequently used communication device among the communication devices having installed thereon the SIMs in a same network as the calling SIM and having the signal strength being greater than or equal to the pre-determined threshold, and sends an instruction to the communication device of the caller to instruct the communication device of the caller to initialize a call to that SIM number via a GSM connection, in case there are multiple communication devices of the callee simultaneously meeting the condition, the service server randomly selects one of those devices and sends an instruction to the communication device of the caller to instruct the communication device of the caller to initialize a call to that SIM number being installed on the randomly selected device via a GSM connection.

33. The service server according to claim 28, wherein:
if the IP connection quality between all communication devices of the callee and the communication device of the caller is less than a pre-determined threshold, and the called SIM is not in a same network as the calling SIM or is in a same network as the calling SIM but the signal strength of the called SIM is less than a pre-determined threshold, and among the other SIMs of the callee there is no SIM in a same network as the calling SIM or there are SIMs in a same network but the signal strengths thereof are all less than a pre-determined threshold, and among the other SIMs of the callee there is one or more SIM having a signal strength being greater than or equal to a pre-determined threshold, the service server selects the most frequently used communication device among the communication devices having installed thereon the SIMs having signal strengths greater than or equal to the pre-determined threshold, and sends an instruction to the communication device of the caller to instruct the communication device of the caller to initialize a call to that SIM number via a GSM connection, in case there are multiple communication devices of the callee simultaneously meeting the condition, the service server randomly selects one of those devices and sends an instruction to the communication device of the caller to instruct the communication device of the caller to initialize a call to the SIM number being installed on that randomly selected device via a GSM connection.

34. The service server according to claim 28, wherein:
if the IP connection quality between all communication devices of the callee and the communication device of the caller is less than a pre-determined threshold, and the signal strengths of all the SIMs of the callee are all less than a pre-determined threshold, the service server selects a communication device having installed thereon the SIM having the greatest signal strength among them, and sends an instruction to the communication device of the caller to instruct the communication device of the caller to initialize a call to that SIM number via a GSM connection, in case there are multiple communication devices of the callee simultaneously meeting the condition, the service server randomly selects one of those devices and sends an instruction to the communication device of the caller to instruct the communication device of the caller to initialize a call to the SIM number being installed on that randomly selected device via a GSM connection.

35. A communication system, wherein the system including the communication device according to claim 13 and a service server, applied to a communication system including a communication device of a caller, a communication device of a callee and the service server, wherein the service server including means configured to:
receive a communication request of the caller and the SIM (Subscriber Identification Module) number of the callee sent from the communication device of the caller;
based on the communication request of the caller and the SIM number of the callee received from the communication device of the caller,
determine whether or not the SIM number of the callee is associated with any global user ID of the callee, where the global user ID of the callee is an ID which is pre-registered at the service server by the callee and is associated with SIM numbers of the callee;
wherein
if it is determined that the SIM number of the callee is associated with a global user ID of the callee,
determine statuses of the communication devices of the callee that having installed thereon the SIMs which are also associated with the global user ID of the callee,
send, to the communication device of the caller, an instruction to initialize a call to the communication device of the callee that has the status meeting a pre-determined condition, via an IP (Internet Protocol) connection or a GSM (Global System for Mobile communication) connection; and
connect the communication device of the caller to the communication device of the callee if the call is initialized via an IP connection;
or
if it is determined that the SIM number of the callee is not associated with any global user ID of the callee,
send, to the communication device of the caller, an instruction to initialize a call for the communication device of the caller to initialize a call to the SIM number of the callee via a GSM connection.
